(19) United States
(12) Patent Application Publication
(10) Pub. No.: US 2006/0275529 A1
(43) Pub. Date: Dec. 7, 2006

(54) Production of edible substrates

(76) Inventors: James F Woodhouse, Tyne & Wear (GB); Stan Holtom, Northumberland (GB); Dawn Barker, Northumberland (GB); Andrew M. Candler, Northumberland (GB); Angela Wright, Northumberland (GB); Denise Metcalfe, Ashington (GB); John R. Russell, Northumberland (GB)

Correspondence Address: FISH & RICHARDSON P.C., PO BOX 1022, MINNEAPOLIS, MN, 55440-1022, US

(21) Appl. No.: 10/550,037

(22) PCT Filed: Mar. 19, 2004
(86) PCT No.: PCT/US04/08673

§ 371 Date: Jun. 28, 2006

Related U.S. Application Data
(60) Provisional application No. 60/456,899, filed on Mar. 21, 2003.

(51) Int. Cl. A22C 13/00

(52) U.S. Cl. 426/87; 426/89; 426/383

(57) ABSTRACT

Methods and systems for making an edible substrate may include depositing an edible material onto a backing material from a slot-coat applicator, a spray applicator or a combination of thereof, to form a substantially planar image-bearing edible substrate suitable for adherence to an edible material. An image may be printed on the edible substrate using one or more printing techniques, including screen printing, offset printing, thermal transfer, ink jet printing, lithographic blanket transfer printing, flexographic printing, letter press rotary relief plate printing, web printing, reel to reel printing and gravure printing.

### CROSS REFERENCE TO RELATED APPLICATIONS

This application claims priority to a pending provisional application entitled “Production of Edible Substrates”, U.S. Ser. No. 60/456,899, filed on Mar. 21, 2003, which application is hereby incorporated herein by reference in its entirety.

### TECHNICAL FIELD

This invention relates to the manufacture of substrates, and in certain embodiments to the manufacture of printable edible substrates.

### BACKGROUND

Decorative images are frequently applied to confections and food articles, such as cakes, pastries, ice cream, and baked goods. Frequently, decorative images are borne on an edible substrate that is transferred to a surface of a food article to be decorated. The edible substrates are often thin, fragile layers of starch-based edible material. Such materials facilitate transfer of the decorative image to the surface of the food article without detracting from the texture or appearance of the original food article. Preferably, the edible substrates are relatively durable so as to withstand the printing and transferring processes.

Edible substrates may be deposited onto a releasable backing paper or film to provide support throughout the printing process and to facilitate handling of the edible substrate. After the edible substrate is properly transferred to the food article, the backing paper may be peeled away to show the decorative image on the surface of the food article.

Conventionally, edible substrates are formed by depositing an edible formulation on a backing paper using “screen printing” process. In such processes, a screen fixture is positioned over the surface of the backing paper and the edible material is manually forced through a screen mesh using a squeegee or other similar device. The properties of previously known edible materials, such as their viscosity and density, made them well suited to deposition in thin layers through a screen mesh.

Screen printing processes, however, are labor-intensive and relatively inefficient. Typically, a worker must manually force the edible material through the screen mesh with a squeegee. The need for such manual intervention slows the manufacturing process and impedes efficiency and throughput.

Relatedly, the process for printing images on this type of edible substrate has been significantly improved. Copending U.S. patent application filed Mar. 18, 2003, by Dawn Barker et al., entitled “Edible Substrates” and commonly assigned herewith and incorporated by reference herein, discloses edible inks and methods of printing edible substrates with high-speed offset printing apparatus. This development has significantly improved image printing efficiency and throughput. By that same token, however, the relatively slow edible substrate screen printing process now accounts for an increased fraction of the total manufacturing cost.

### SUMMARY

Certain embodiments of the invention provide a method for producing edible substrates in a high-speed, automated environment. This method of production can be synergistic with downstream printing processes that apply edible ink to the substrate, such as a high-speed lithographic process adapted to handle the relatively fragile edible substrates.

A system for producing edible substrates can include a slot-coat applicator to deposit a substrate of edible material having a thickness of about 50 micrometers to about 750 micrometers onto a surface of releasable backing paper, a drying system to heat the edible substrate and remove at least a portion of moisture content from the edible material, and a cutting system to cut the backing paper to a predetermined sized.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of an edible substrate formed on a backing material.

FIG. 2 is a cross-sectional view taken along line 2-2 of a portion of the edible substrate and backing material depicted in FIG. 1.

FIG. 3 is a side view of an edible substrate production line.

FIG. 4 is a side view of a slot-coating applicator from the production line of FIG. 3.

FIG. 5 is a side view of a spray applicator.

FIG. 6 is a side view of a rotary cutter from the production line of FIG. 3.

FIG. 7 is front view of the rotary cutter of FIG. 6.

FIG. 8 is a front view of a horizontal linear cutter.

FIG. 9 is a front view of a vertical linear cutter.

Like reference symbols in the various drawings indicate like elements. The objects are not necessarily shown to scale.

### DETAILED DESCRIPTION OF ILLUSTRATIVE EMBODIMENTS

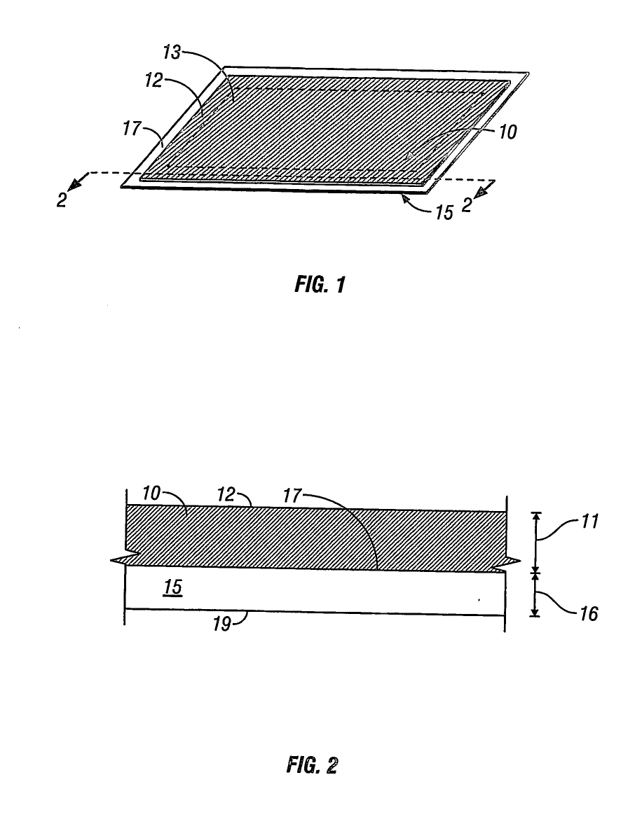

FIGS. 1 and 2 show a substantially planar edible substrate 10 formed on a backing material 15. The backing material 15 may include any food compatible backing paper, such as a polyethylene-coated release paper supplied by Cotek Papers, Ltd. of Draycott, England. The edible substrate 10 may be formed on the backing material 15 in various dimensions, and preferably, the edible substrate 10 is formed to have an exposed surface 12 that is slightly larger than the maximum print area 13 of the printing equipment used to apply edible ink (not shown) to the substrate 10. In one embodiment, the edible substrate 10 may have dimensions of about 470-mm×270-mm, which are slightly greater than the maximum print area of about 450-mm×250-mm of a particular printing machine (not shown). The backing material may also be provided in the form of a continuous web, as described in further detail below.

Other conventional release liners can be used as the backing material 15. Suitable materials for a backing to hold or carry a substrate include, but are not limited to, corona-treated paper, wax coated paper, polymeric films, plastic, cellulose, polyethylene, or polypropylene coated paper, and the like. Preferred release liners are those in which a composition can be applied (by e.g. pouring, coating, spraying, screening, etc.) yet can also separate from a semi-solid substrate without damaging (e.g. fracturing) the substrate.

Referring to FIG. 2, the backing material may preferably have a thickness 16 that is sufficient to provide support for the edible substrate 10 in downstream processes, such as deposition, drying, and cutting. In one embodiment, the backing material 15 may have a thickness 16 of about 180 micrometers, and the edible substrate 10 formed thereon may have a thickness 11 of about 250 micrometers. Thicker edible substrates 10 may be produced, if desired, particularly when an image transfer or printing process does not limit the thickness of the substrate 10. Different embodiments of the edible substrates 10 may have thicknesses 11 that range from about 50 micrometers to 750 micrometers, preferably from about 100 to 500 micrometers, and more preferably from about 200 to 350 micrometers. The latter of these ranges can with certain edible substrate formulations provide an optimal degree of structural integrity, ease of handling, texture and taste characteristics, humidity resistance, ink acceptance, and/or bake-ability.

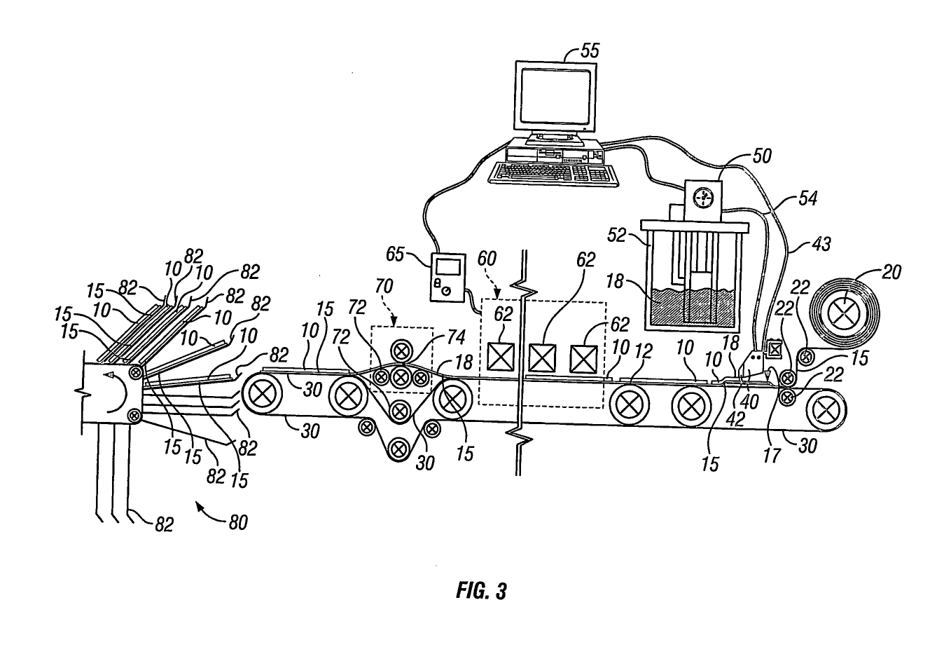

FIG. 3 shows a system for producing edible substrates 10 in accordance with an embodiment of the invention. The backing material 15 may be fed from a reel 20 and tension controllers 22 onto a conveyer belt 30, web rollers, or other means for carrying the web of backing material downstream. The backing material 15 is fed through a slot-coat applicator 40 where the edible material 18 is deposited onto a surface 17 of the backing material 15. The slot-coat applicator 40 may include one or more valves 42 that function to open and close the flow of edible material 18 from the applicator 40 (described in more detail below). As the web of backing material travels past the slot coater 40, the flow of edible material 18 may be throttled on and off to create discrete substrates 10 on the moving web.

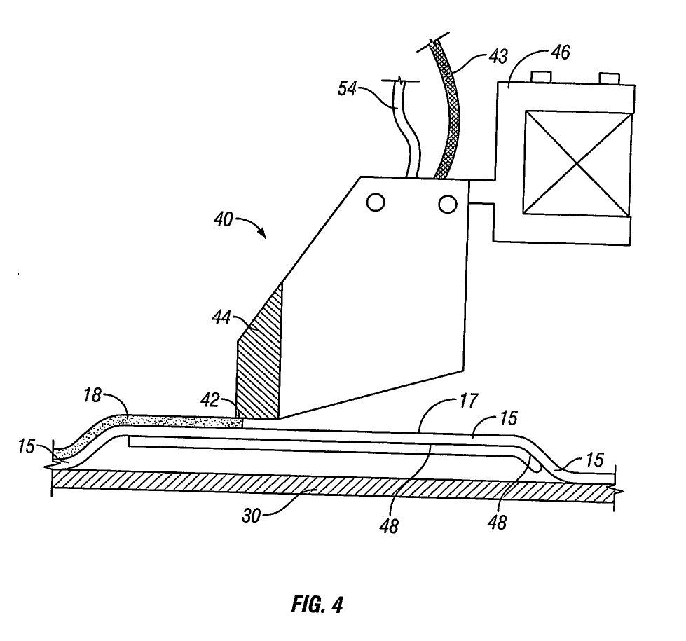

The edible material 18 may be provided to the slot-coat applicator 40 from a flexible hose 54 connected to a reservoir 52. Preferably, a pressure pump 50 may be used to deliver the edible material 18 to the slot-coat applicator 40 at a substantially constant pressure so as to enable constant flow from the applicator slot (described in more detail below; refer to FIG. 4). In one example, the pressure pump 50 may be a lid-mount pump system, which is supplied by Nordson Corporation of Duluth, Ga., capable of delivering material at a rate of about 0.1 to about 0.5 L/min. A programmable logic controller 55 may be used to regulate the pressure and output of the edible material 18 from the pressure pump 50 to the slot-coat applicator 40. Suitable controllers 55 include the SIMATIC PLC available from Siemens Corporation and the PLC5 from Allen-Bradley Corporation (now Rockwell Automation of Great Britain). PC-based controllers may also be used. The control unit 55 may be used to control other systems that affect the timing of the production line, such as the conveyor belt 30, the slot-coat applicator 40, the drying system (described in more detail below), and the cutting system (described in more detail below).

After the edible material 18 is deposited as a substantially planar substrate 10 on the surface 17 of the backing material 15, a drying system 60 may be used to remove moisture from the edible material 18. The backing material 15 and the edible material 18 deposited thereon may travel on the conveyor belt 30 through the drying system 60, which includes one or more drying units 62. Optionally, the drying system 60 may include a separate conveyor system that can withstand repeated exposure to the heat or another energy source from the drying units 62. In such an embodiment, the separate conveyor system may receive the edible substrates 10 and backing material 15 from the conveyor belt 30 so that the conveyor belt 30 is not directly exposed to the drying units 62.

In the drying system 60, the edible substrates 10 may be exposed to heat or another energy source that is provided by the drying units 62. In one embodiment, the drying units 62 emit infrared (IR) radiation. Suitable IR drying units include the IRT-Monocassette unit available from Solaronics IRT S.A. of Armentieres, France. Depending upon the rate of motion of the edible substrates 10 through the drying system 60, a plurality of drying units 62 may be spaced apart along the exposed surface 12 of the edible substrates 10 such that the drying system 60 may extend for more than 1 meter along the conveyor path. By the same token, if the line speed is sufficiently low, the moisture from the edible material 18 may be removed using a single drying unit 62. Optionally, the drying system 60 may be equipped with fan units (not shown) or other air-movement devices so as to exhaust heat and humid air produced by the drying units 62. In one embodiment, the rate of motion of the edible substrates 10 through the drying system 60 is about 0.1 meters/second (about 20 feet/minute), and the radiation intensity of the drying units 62 is set so that moisture is removed from the deposited layer of edible material 18 to reduce the weight of the material 18 by about 30% to 50% (preferably about 40%).

A drying system programmable logic controller 65 may be networked with the drying units 62 to regulate the IR radiation intensity level. In one embodiment, the drying system control unit 65 is capable of adjusting the heat intensity of the individual drying units 62 with respect to the rate of conveyor motion. Thus, if the production line halts due to the failure of another system, the drying system control units 65 would reduce the heat intensity from the drying units so that the edible material 18 in the drying system 60 is not overexposed. Furthermore, the programmable logic controller 55 may manage the operation of the drying system control unit 65 in relation to the timing of other systems in the production line, or the programmable logic controller 55 may be set up to configured to control the drying system 60 without the need for the drying system control unit 65.

A cutting system 70 may be used to cut the backing material 15 into separate sheets and divide the edible substrates 10. The cutting system 70 may use one or more tension controllers 72 to separate the backing material 15 from the conveyor belt 30 such that the conveyor belt 30 is not exposed to the cutting blade 74. In the embodiment shown in FIG. 3, the cutting system is a rotary cutter 70 that may be positioned to repeatedly cut the backing material 15 in the gap between the individually deposited substrates 10 after the edible material 18 has been exposed to the drying system 60.

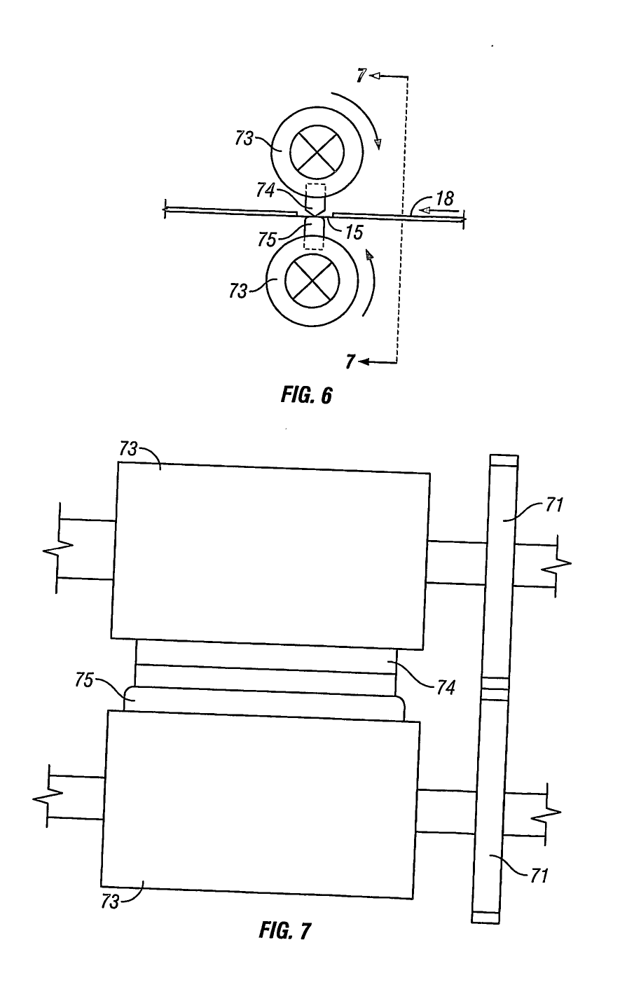

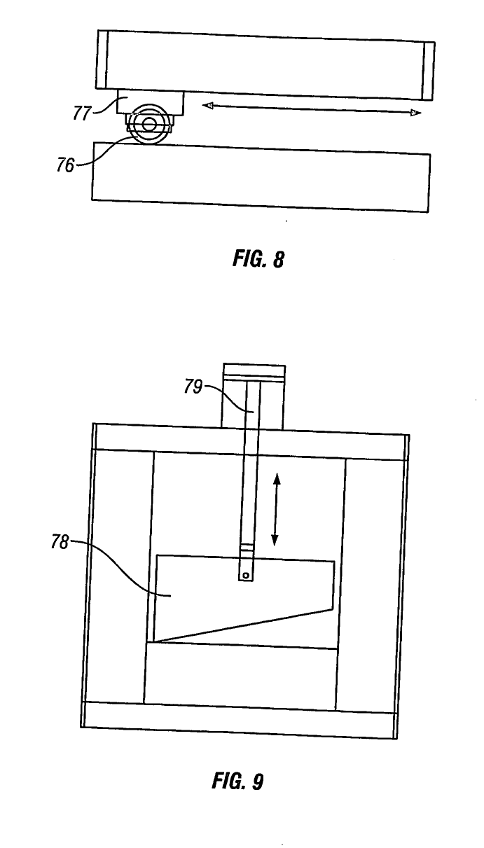

FIGS. 6-7 show the rotary cutter of FIG. 3 in more detail. The backing material 15 may be cut when the cutting blade 74 contacts an opposing surface 75 that is substantially rigid. The cutting blade 74 and opposing surface are attached to substantially parallel rollers 73, which may be synchronously rotated using mating gears 71. Alternatively, the cutting system 70 may use a means other than a rotary cutter, such as a horizontal linear cutter. Referring to FIG. 8, a horizontal linear cutter may employ a cutting wheel blade 76 attached to a carrier 77, which provides motion in the horizontal direction for the blade 76. As such, the wheel blade 76 may cut the backing material 15 as the carrier 77 is moved in a horizontal direction that is substantially perpendicular to linear direction of the conveyor belt 30 and backing material 15. In another embodiment shown in FIG. 9, the cutting system 70 may use a vertical linear cutter to cut the backing material 15 into separate sheets. The vertical linear cutter employs a cutting blade 78 attached to a vertical carrier 79. The vertical carrier 79 may reciprocate the cutting blade 78 so that the backing material 15 is cut in the gap between the individually deposited substrates 10.

Upon completion of the cutting process, the properly sized backing material 15 and corresponding edible substrate 10 are output to the conveyor belt 30 or other conveyor means by which the substrates 10 may be transported to storage-drying system 80. In the embodiment shown in FIG. 3, the storage-drying system is a wicket dryer system 80 that separately receives each edible substrate 10 using wickets 82. A suitable wicket dryer system 80 may be provided, for example, by Trumax Ltd. located in Bristol, England. As the wickets 82 transport the edible substrates 10 and their corresponding backing material 15 in the wicket dryer 80, the edible substrate 10 may be retained at an angled position (e.g. non-horizontal) to increase storage capacity and to substantially expose both the top and bottom surfaces 12 and 19 (FIG. 2) of the substrate-backing combination. Depending on the mixture of edible material 18 and the downstream manufacturing requirements, the wicket dryer system 80 may include drying units (not shown) that expose the edible substrates 10 to heated air, or the edible substrates 10 may be dried in ambient air, as the edible substrates 10 are transported to a subsequent storage device or printing process.

In an exemplary method, water can be removed by drying the substrate in an oven for about 20 to about 40 minutes, at an average temperature of about 50° C. While not intending to be bound by theory, it is estimated that approximately 90 to about 95% of the water can be removed after about 40 minutes at 50° C., for substrates that are less than about 25 micrometers thick. The time and temperature ranges can be adjusted to correspond with a substrate thickness as well as the type and capacity of the heating equipment. As a final product, as it would be presented to its packaging, or at the point of transferring onto a food item, a substrate typically has enough moisture so that it is sufficiently flexible so it does not fracture, yet can be removed from a release liner if one is present. For example, a substrate can have about 5 to about 10% moisture. The edible substrates 10 can be packaged and/or stored until a later time, for handling and processing in a separate process or facility or by a subsequent manufacturer or printer. Packaging such as bags, envelopes, boxes, and the like can be used to wrap and protect a substrate. Any conventional food packaging material can be used, but particularly useful materials are those that are would not have any deleterious effects on a substrate. Packaging having a good moisture vapor barrier is useful. Substrates made from certain compositions of the invention can maintain their stability when packaged in a substantially impervious container, particularly if the packaging can maintain the moisture retained in the substrate. Exemplary materials that packaging can be made from and are suitable for a substrate according to the invention include for example, polypropylene films, polyester films such as MYLAR® (E.I. du Pont de Nemours and Company; Wilmington, Del.), foils (e.g. aluminum) and the like. A printed or unprinted substrate made from a composition of the invention can be stored in a freezer, or at room temperature. A cool environment can be conducive to maintaining freshness of the substrate. Upon removal from a cooler or freezer, a substrate can be thawed and subsequently used to accept a transferred image, or can be directly adhered to a food item. A substrate, whether or not it bears an image, advantageously does not suffer deleterious effects when subjected to a freeze thaw regiment.

An image can be placed onto a surface of a substrate using any suitable process, such as a silk screen printing process, offset printing, thermal transfer, ink jetting, etc. An image can include, for example, informative indicia (e.g. dates, names, etc); pictures or illustrations of people, places and things; patterns; decorative art; and other aesthetic images. Substrates made according to embodiments of the invention can exhibit ability to hold and maintain the quality and integrity of an applied image. For example, images applied with an edible ink can be placed on certain substrates and maintained such that no significant or undesirable bleeding, fading, refractivity, haziness occurs. An image can be quite clear and aesthetically pleasing when applied onto a whitened substrate, such as those made from compositions according to the invention that include a whitening agent. Substrates with increased opacity can provide clear images, typically when used on food items such as frosted cakes and other pastries.

An image can be applied in-line, as a substrate is made, just after a substrate reaches its non-flowable state, or at a later stage in a manufacturing process. It may be possible that a non-image bearing substrate can be initially applied to a surface of a food item and then positioned to receive an image. Again, this can occur in-line, or off-line. Numerous types of edible or comestible products can have a substrate applied to it. Items, such as, but not limited to, pastries, iced cakes, pasties, ice-cream, cream, candy, vegetables, and meat products are food items that can be decorated, adorned or enhanced by a substrate according to the invention. An image can be made from an edible ink formulation, applied to the substrate in any suitable printing apparatus or process. For example, printing processes that may be used include silk screen, wet offset, lithographic blanket transfer, flexographic Anolux roller transfer, letter press rotary relief plate, web print, reel to reel, and gravure. Suitable printing apparatus include dry offset printers available from Heidelberg Druckmaschinen AG, Heidelberg, Germany, A.B. Dick-Itek Limited, Middlesex, England and Sakurai Machinery, Koto-ku, Tokyo, Japan.

FIG. 4 shows the slot-coat applicator 40 and associated slot coating process in further detail. The edible material 18 may be supplied to the slot-coat applicator 40 using the flexible hose 54 from the pressure pump 50 (see FIG. 3). The slot-coat applicator 40 includes a mounting device 46 to suspend the applicator slot 42 at the appropriate height above the backing material 15. In one example, the slot-coat applicator 40 may be a modular dispensing gun system provided by Nordson Corporation of Duluth, Ga. One or more valves 44 may operate to open and close the flow of edible material from the applicator slot 42. Such valves 44 may be electrically connected to the control unit 55 via cable 43. Alternatively, the valves 44 may be pneumatically controlled and a flexible hose (not shown) may be used to supply pressurized air to the valves. The backing material 15 may be slightly lifted from the conveyor belt 30 by an applicator guide 48, which may maintain the backing material 15 at a substantially constant distance from the applicator slot 42. The backing material 15 may move under the applicator slot 42 while the valves 44 operate to open and close the flow of edible material 18 in a repeating sequence so that a spaced array of edible substrates 10 are deposited along the span of backing material 15. Small gaps may be provided between the depositions of edible substrates 10 to facilitate cutting the backing material 15 in the cutting system 70 (FIG. 3) such that the edible substrates 10 may be divided from each other by cutting the backing material 15 in the small gaps.

The dimensions of the edible substrate 10, such as the thickness 11, may be adjusted by the size of the slot 42, the pressure of the material 18 supplied the pressure pump 50, and the linear speed of the backing material 15 with respect to the applicator slot. The pressure from the pump 50 may vary from about 40 psi to 700 psi depending on the desired dispensing operation and other known variables. In the embodiment shown in FIG. 4, the applicator slot 42 is positioned above the backing material 15 such that the edible material 18 is dispensed in a substantially vertical direction onto the backing material 15. Alternatively, the applicator slot 42 can be positioned to dispense the edible material 18 in a substantially horizontal direction such that the backing material 15 contacts a bottom edge of the applicator slot 42 while the edible material 18 is being dispensed thereon.

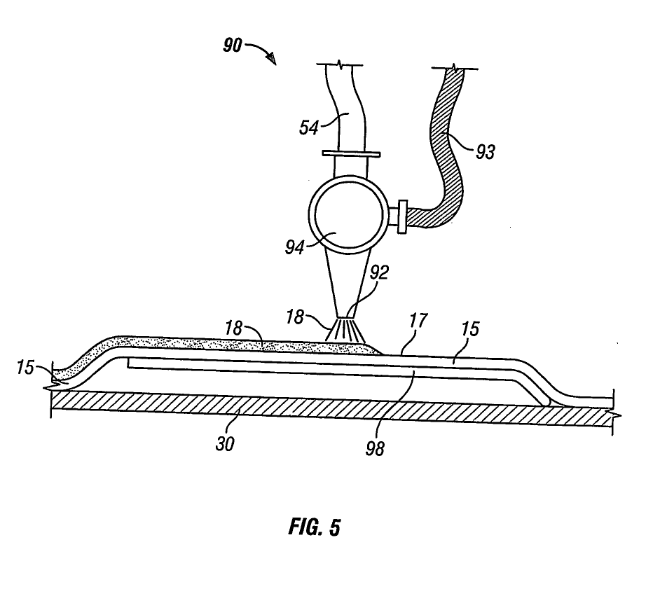

FIG. 5 shows an alternative system for dispensing the edible material 18 on to the backing material 15, in accordance with another embodiment of the invention. A spray applicator 90 or an array of spray applicators 90 may be used in place of, or in combination with, the slot coat applicator 40. In one example, one or more suitable spray applicators 90 operate at a working air pressure of about 40-50 psi with a maximum spray pattern of about 240-270 mm. Suitable spray applicators include model 672-067 by supplied by Ingersoll-Rand Company Limited of Hamilton, Bermuda. Alternate spray systems include the DeVilbiss GTi-A Automatic Spray Gun from ITW Finishing UK located in Bournemouth, England. The edible material 18 may be provided to the spray applicator 90 from the pressure pump 50 (FIG. 3), and a one or more valves 94 operate to open and close the flow of material 18 dispensed from the sprayer nozzle 92. The valves 94 may be pneumatically controlled, and a flexible hose 93 may be used to supply pressurized air to the valves. Alternatively, the valves 94 may be electrically connected to the control unit 55.

As in the slot coating embodiment, the backing material 15 may be slightly lifted from the conveyor belt 30 by an applicator guide 98, which may maintain the backing material 15 at a substantially constant distance from the sprayer nozzle 92. The backing material 15 may move under the sprayer nozzle 92 while the valves 94 operate to open and close the flow of edible material 18 in a repeating pattern such that an array of edible substrates 10 are deposited along the span of backing material 15. Optionally, small gaps may be provided between the spray depositions of edible substrates 10 to facilitate the cutting of the backing material 15 in the cutting system 70 (FIG. 3). Depending on the properties of the edible material 18, and the rate of deposition from the sprayer nozzle, more than one spray applications may be required to achieve the desired thickness 11 of the edible substrate 10. For instance, in certain embodiments the nozzles deposit about 0.002-0.003 inches of edible material 18 on the backing material in a single pass. In order to build the substrate 10 up to a thickness 11 of about 0.010 inches, the edible material 18 may be dispensed by using three sets of sprayers or by cycling the backing material 15 through a single spraying station three to four times. In such embodiments, the edible material 18 maybe exposed to a drying system 60 before subsequent additional depositions from a bank of spray applicators 90.

The deposition quality of the slot-coat applicator 40 and the spray applicator 90 may vary depending on the physical characteristics of the edible material 18 that is being dispensed. The mixture of ingredients in the edible material may be adjusted according to ambient conditions, including temperature and humidity. In some circumstances, the physical characteristics of the edible material 18, such as the viscosity, may change when the mixture is altered. The viscosity for different mixtures of the edible material 18 may range from 1000 to 9000 centipoise. Many mixtures having higher viscosities are well suited to the slot-coating technique described above, whereas many lower viscosity embodiments are better suited to spray deposition.

### EXAMPLE

One implementation for preparing a edible substrate is as follows. A polyethylene-coated release paper (supplied by Cotek Papers, Ltd. of Draycoft, England) having a width of about 500 mm and thickness of about 180 micrometers is moved on a conveyor belt to a slot-coat applicator at a rate of about 0.1 meters/second (about 20 feet/minute). A starch-based, edible material having a density of about 1.098 g/ml and a viscosity of about 3,232 centipoise (calculated using a No. 2 Zahn cup) is provided to the slot-coat applicator, which is a modular dispensing gun system provided by Nordson Corporation of Duluth, Ga. The edible material is supplied to the slot-coat applicator at a substantially constant pressure of about 350 psi using a pressure pump provided by Nordson Corporation of Duluth, Ga. The slot-coat applicator includes pneumatic valves that controlled the flow of edible material from the applicator slot, which have an approximate width of about 470 mm. The valves are manipulated such that the edible material is deposited as separate substrates, each having a length of about 270 mm and a thickness of about 250 micrometers, along the span of releasable backing paper with about 30 mm gaps between the substrates.

The edible substrates are transported along a conveyor system though an IRT drying system, which was provided by Solaronics IRT S.A. of Armentieres, France. The drying system includes a series of spaced-apart IRT-monocassette drying units that spanned a length of about 20 meters, and each drying unit is capable of providing up to 3 kW of power to heat the edible substrates and remove a substantial portion of the moisture content (approximately 40% of the weight of the edible material in thisembodiment). After the edible material is sufficiently dried to a substantially non-flowable state, the edible substrates is transported through a rotary cutting system. The span of releasable backing paper is cut into individual sheets having dimensions of about 500 mm×300 mm, each sheet having one edible substrate (dimensions of about 470 mm×270 mm) approximately centered thereon. The cut backing paper and the corresponding edible substrates thereon are transported using a conveyor from the rotary cutting system to a wicket drying system provided by Trumax Ltd. of Bristol, England. The wicket drying system includes a sheet jogger to transport each sheet into an individual wicket and to gently collect the sheets as they offload from the wickets. Upon completion of the wicket drying system, the edible substrates are prepared for a printing process in which a design is applied to the exposed surface of the edible substrate using edible ink.

### Edible Substrate Formulations

Formulations suitable for use as the edible material 18 in the foregoing processes may include starch, water and ingredients that cooperate to provide a formulation that can be made using a variety of substrate manufacturing techniques and result in substrates that are environment tolerable. In particular, components in a starch-based composition can include, for example, an emulsifier, a plasticizer, a stabilizer, a humectant, and a texturizer. Depending on the total amount of each ingredient and the types of ingredients present in the composition, a specific component or ingredient can be multi-functional and serve in one or more of the described capacities.

The starch in the composition can be used to primarily provide a base solid material or structure forming material. The starch can be used in unrefined, refined, unmodified or modified form. Exemplary starches include those based from maize (corn), potato, wheat, and tapioca starch. The amount of starch in a composition of the invention can be about 5 wt % to about 28 wt %, a suitable range also being about 6 wt % to about 25 wt %. Certain compositions can include about 8 wt % to about 15 wt % starch. Gum acacia can optionally be included with the starch, adding to the structure forming material, at concentrations up to about 17 wt %.

Water can be present in the composition at about 25 wt % to about 70 wt % of the total weight of the composition. Certain embodiments can have about 28 wt % to about 52 wt % water, and particular formulations can have about 35 wt % to about 45 wt %. Other useful compositions can have about 50 wt % to about 65 wt % water.

Including an emulsifier in an edible composition in accordance with an exemplary formulation of the invention can be beneficial in ensuring homogeneity. The amount of emulsifier in a composition can be up to about 10 wt % of the total composition. Exemplary compositions can include up to about 5 wt % emulsifier, and other compositions can include about 0.5 wt % to about 1.5 wt % emulsifier. Suitable emulsifiers include for example, lecithin, polyglycerol polyricinoleate, acetic esters of monoglycerides, polyoxyethylene sorbitan monostearate (e.g. commercially available products such as POLYSORBATE 60, CRILLET, CRILLET VEG A, and TWEEN), and combinations thereof. A useful emulsifier is a product commercially available under the trade designation POLYSORBATE 60. Combinations of suitable emulsifiers can also be used in the composition. Substrates made from an exemplary composition according to the invention can exhibit an improved capability of holding (bearing) an applied image when the composition includes an effective amount of emulsifier. This helps achieve and maintain the clarity of an image applied to a substrate.

Including a plasticizer in the composition can impart a peelable, flexible characteristic to a resultant substrate made from a composition of the invention. Providing a flexible substrate can be beneficial in certain image printing techniques, such as off-set printing, where the substrate may need to be manipulated in, for example, axial or radial directions. The plasticizer is also useful for ensuring that a substrate is peelable or removable from its carrier, such as a release liner. Transferring a substrate to a target food item is desirably accomplished without structural defects to the substrate, such as flaking, fracturing, etc. A preferred plasticizer is glycerin. Thus, easy or smooth removal from a release liner can prevent such damage. Compositions according to the invention can include up to about 10 wt % plasticizer; up to about 5 wt % plasticizer is also suitable for exemplary compositions.

A stabilizer can be useful in an edible composition to prevent separation of the ingredients, such as the solids from the liquids, or the fatty phase from the aqueous phase. Including a stabilizer also helps maintain the viscosity necessary to process the composition. A stabilizer can be present in the composition at up to about 16 wt %, based on the total weight of the composition. In one implementation, a stabilizer can be included at about 2 wt % to about 6 wt %; other compositions can include about 5 wt % to about 12 wt % stabilizer. Examples of useful stabilizers for the composition include one or more ingredients chosen from locust bean gum, arabic gum, acacia gum, polysorbate, sodium alginate, starch, xanthan, acetic esters of monoglycerides, and polyglycerol polyricinoleate, sorbitol, and starch. In exemplary embodiments, a stabilizer can advantageously work in additional capacities, such as a suspension agent, or a thickener (e.g. viscosity modifier). Acacia gum, for example, can function as a stabilizer in the composition, yet can also impart thickening and structure forming features. When used as a viscosity modifier, a stabilizer can be present in a composition in any amount that imparts sufficient viscosity so that a composition is processable (e.g. spreadable). Many substrate manufacturing techniques, such as spray coating, screen printing, and slot coating typically require a composition to have a viscosity of about 1000 to about 9000 centipoise (cP). Lower viscosity compositions may be more conducive to spray coating, while the higher viscosity compositions tend to be capable of being processed by coating (e.g. slot coating) or screen printing, for example. Achieving a lower viscosity composition may involve adding higher amounts of water (e.g. greater than about 50 wt %) and/or adjustments to the concentration of other constituents of the composition. These compositions, having a viscosity of about 1000 to about 2000 cP, can be particularly suitable for spray applications.

A humectant can be present in the composition at about 5 wt % to about 35 wt % of the composition, and can be achieved by using one or more of, for example, sorbitol, glycerine, and sugars, such as icing cane sugar (e.g. sucrose), fondant icing sugar, xylitol, glucose, and fructose. Useful formulations for exemplary compositions include about 2 wt % to about 6 wt % humectant, and also about 6 wt % to about 10 wt % humectant; while others can include 10 wt % to about 16 wt %. Humectants can be used to retain the moisture of a composition and thereby impart flexibility to the composition once it has been formed into, for example, a substrate. Desirably, substrates are sufficiently flexible so it can be handled without fracturing or falling apart.

Compositions of the invention can also include a texturizer, an ingredient that can help a mixture flow, such as what occurs when substrates are made. A texturizer can retain and/or bind the water, to provide a flowable, pourable, coatable, extrudable or sprayable composition. Materials that can be used as the texturizer include, but are not limited to, acacia gum, Arabic gum, glucose, fructose, sucrose, and combinations thereof The texturizer can be present in the composition at about 1 wt % to about 20 wt %, and also between about 7 wt % to about 15 wt %.

As noted above, substrates made in accordance with the invention can be used for decorating confectionary foods that are often cut into individual pieces, such as what is often done with a cake. In these applications, it is generally desirable that the substrate easily cuts without fraying or fracturing and maintains the integrity of an image (if one exists on the substrate). This cuttability feature can be achieved by optionally using a disintegrant. The disintegrant can be present up to about 12 wt %, however, the amount can be adjusted according to a particular application of a substrate. A useful disintegrant material is microcrystalline cellulose.

Other optional additives that can be included in compositions of the invention including, but not limited to, sweeteners, color enhancing agents, preservatives, flavoring, and rheology modifiers. Suitable sweeteners include for example, sorbitol, glucose syrup, fructose, sucrose, dextrose, aspartame, and sugars such as icing cane sugar and fondant icing sugar. Use of sweeteners can also be beneficial in applications where a composition is made into a freezable substrate since a sweetener can change (e.g. depress) the freezing point and also aid in freeze-thaw stability of a substrate. Certain sweeteners such as sorbitol, have many useful characteristics that impart various features to the composition beyond just sweetening; therefore it can be beneficial to use sorbitol as a sweetener as it may serve other functions in the composition as described above. Dextrose, in the form of dextrose monohydrate can also be useful, as it can add smooth and cooling taste to the composition. In an embodiment of the invention, the sweetener can be in a composition at a concentration up to about 30 wt %, a suitable range also being about 5 wt % to about 15 wt %. The amount of sweetener, however, can be adjusted according to a desired taste. Color enhancing agents can be, for example, whiteners, colorants, inks, dyes, or pigments. Certain substrates are often desirably whitened for aesthetic reasons, particularly when used for decorating pastries such as cakes, cupcakes, and the like. A popular whitening agent for confectionary applications is titanium dioxide. In the practice of the invention, up to about 4 wt % titanium dioxide can be used in an exemplary composition. Any known pigment approved for human consumption may be used as the color enhancing agent, including, for example, carmoisine, quinoline, ponceau 4R, blue 1, vegetable carbon, blue V, blue 2, and FD&C pigments such as yellow 5, red 3, red 40, blue 1, and blue 2. A preservative can be added to a composition to increase the shelf life and inhibit microbial growth (e.g. microorganisms including, but not limited to yeast, mold, bacteria). Up to about 1 wt % of a preservative can be added to an exemplary edible composition of the invention. Examples of useful food preservatives for the compositions of the invention are citric acid, potassium sorbate, sorbic acid, sodium benzoate, EDTA and combinations thereof. Flavoring agents for embodiments of the invention can include citric acid, vanilla, and any other edible natural or artificial flavorant. The flavoring agent can be present up to about 1 wt % of the composition.

Optionally, a fatty phase comprising oil can be included in a composition of the invention as a rheology modifier. The oil can be any edible oil, and preferably a vegetable oil, such as one derived from for example, rapeseed, corn, and soy. A combination of oils can also be used. In an embodiment, rapeseed oil is used to enhance the behavior of the composition as it is applied to a backing such as a release liner. In particular, rapeseed oil can assist and enhance the composition's ability to coat (e.g. lay or spread on) a waxy release liner. An oil can be present in a composition at up to about 15 wt % of the total composition.

A suitable edible substrate formulation can be made by first dry blending all the dry ingredients except the color enhancing agent if used. The liquid ingredients, including the emulsifier are then blended together into a separate mixture. The optional color enhancing agent is then added to the liquid mixture and dispersed therein using a high shear mixer. This mixing is generally performed for approximately 5 minutes, although the mixing time can be adjusted according to amounts used. The fatty phase ingredients (e.g., lecithin and/or oil) are initially heated to, for example about 70-80° C. and then added to the liquid mixture and dispersed therein using a high shear mixer. Finally, the liquid mixture (with fatty phase) is then added to the blended dry ingredients and mixed for a sufficient time to achieve a well-mixed blend. Mixing time for the final blend can typically take, for example, 5 minutes, although time adjustments can be necessary for larger or smaller volumes of compositions, or for equipment that may have different mixing speeds and capacities.

Exemplary compositions, when made into planar substrates, demonstrate high tolerance to extreme temperatures and levels of humidity. In one embodiment of the invention, a substrate (whether it is imprinted upon or not) is capable of withstanding a freeze thaw regime without suffering any deleterious affects thereto. Thus, substrates made from a composition of the invention can be conveniently frozen (e.g. manufactured, stored etc.) at about 0° C. or less, and allowed to thaw at, for example, room temperature, when ready for use or handling (e.g. shipping). A substrate made from a composition of the invention can be also be, for example, frozen, thawed, and then heated to, for example, cooking temperatures. In an aspect, a substrate can be stable in freezing temperatures, yet maintain its integrity even after being subjected to cooking temperatures, such as above 75° C. It has been found, for example, that image-bearing substrates made from certain compositions according to the invention demonstrate an ability to maintain the integrity of the substrate and the quality of an image (e.g. definition and clarity) after being exposed to baking conditions (e.g. temperatures greater than about 93° C.). Thus the image bearing substrate can be placed on a partially processed or unprocessed food product before being subjected to the final cooking process, which can be any of a variety of methods such as baking, grilling, frying, broiling, etc. These cooking techniques can sometimes reach up to about 275° C. However, for deep frying, for example, the temperature range can be lower, depending what type of oil is used. With certain compositions, a substrate can be made to optionally expand with its target food item, such as what occurs with dough-based products. Upon expansion, the image can maintain its definition even as the product becomes fully processed.

A temperature range in which a substrate according to the invention can be stable is from about -35° C. to about 275° C. Edible compositions can be formulated to provide substrates that are stable within about 0° C. to about 20° C., while others can withstand temperatures of about 18° C. to about 32° C. and maintain their stability. Stability can be in regards to the structure of the substrate, as well as its freshness (e.g. edibility, taste, color, etc). A stable substrate would not, for example, experience any significant and/or unexpected softening or hardening which would make it difficult to process for image application or for placement onto a food item. Some softening can occur when a substrate is subjected to added heat, such as in cooking. However, this would not be considered instability, as the softening is expected and desirable, and can help keep the substrate in place on the food surface. A stable substrate also describes one that does not fall apart upon any process-appropriate handling. Furthermore, a stable substrate would typically not experience any significant or undesired discoloration or change in taste.

A substrate formed from a composition described herein can be highly tolerable to both low and high humidity levels. Environments of substantially no to low humidity, such as about 5% RH (relative humidity) typically would not affect the integrity of the substrate. Thus, a substrate made from a composition according to the invention can be stable in an environment having greater than about 5% humidity. Even more advantageously, a substrate can be tolerable of high humidity levels. For example, a substrate according to the invention can be stable above about 50% RH, a humidity level at which conventional substrates can experience detrimental effects. Certain substrates can even withstand humidity levels of up to about 100%. In high humidity conditions, exemplary compositions of the invention that are formed into substrates as a layer on a compatible backing or release liner can conveniently be transferred to a food item without fracturing or falling apart.

Formulation 1

A composition with the ingredients listed in Table 1 was made by first mixing the dry ingredients, except the titanium dioxide. The liquid ingredients were then mixed together. The fatty phase ingredients were heated to about 70°-80° C. and then admixed to the liquid mixture. The dry mixture was then mixed to the liquid/fatty phase mixture and blended well. All the mixing was performed with a high shear homogenizer.

An amount of the composition was coated onto a wax coated paper as a sheet (approximately 30.5 cm×30.5 cm) and oven dried in a series of heat treatments that averaged to about 50° C and totaled forty minutes of oven baking. The heat treatments were performed in an oven equipped with an infrared heating element (IRT-Monocassette w/Control Unit from Solaronics IRT S.A.; Armentieres, France). The composition layer was considered to be substantially non-flowable after some oven heating, and considered fully cured prior to applying an image thereon. Various sample sizes and shapes were cut (e.g. die-cut) from the substrate sheets, all samples dimensioned to fit on a food item. Each sample was then applied to a food item and subjected to cooking conditions, including baking, grilling and frying.

Samples that were baked were placed on biscuits, scones or pies then heated to about 160° C. to about 250° C. Samples that were deep fried were applied on chicken pieces (e.g. nuggets) and sausage rolls, and then fried at about 180 to about 200° C. Grilled samples were chicken and fish pieces that bore imaged substrate samples; these were grilled at 160 to about 200° C.

All samples cooked according to techniques described above were observed to be stable and capable of maintaining the quality of the image even after the cooling step.

TABLE 1

| | | % by wt. | Wt. in Kg |
|---|---|---|---|
| Dry | Gum Acacia | 14.04 | 6.06 |
| Ingredients | Maize Starch | 13.34 | 5.76 |
| | Microcrystalline Cellulose | 1.95 | 0.84 |
| | Xanthan | 0.70 | 0.30 |
| | Titanium Dioxide | 2.90 | 1.25 |
| | Modified Starch | 0.49 | 0.21 |
| | Potassium Sorbate | 0.14 | 0.06 |
| Liquid | Water | 41.70 | 18.00 |
| Ingredients | Sorbitol | 9.27 | 4.00 |
| | Glycerine | 4.63 | 2.00 |
| | Polysorbate 60 | 0.97 | 0.42 |
| | Vanilla Flavoring | 0.12 | 0.05 |
| Fatty | Lecithin | 0.51 | 0.22 |
| Phase | Rapeseed Oil | 9.27 | 4.00 |
| | Total | 100.00 | 43.17 |

Formulation 2

A composition with the ingredients and amounts listed below in Table 2 was made in similar fashion to the mixing procedure of Example 1.

TABLE 2

| | | % By Wt. | Wt. in Kg |
|---|---|---|---|
| Dry | Maize Starch | 14.48 | 6.91 |
| Ingredients | Microcrystalline Cellulose | 6.34 | 3.02 |
| | Gum Acacia | 6.24 | 2.98 |
| | Icing Cane Sugar | 5.03 | 2.40 |
| | Dextrose Monohydrate | 4.23 | 2.02 |
| | Titanium Dioxide | 3.15 | 1.50 |
| | Modified Starch | 0.50 | 0.24 |
| | Citric Acid | 0.30 | 0.14 |
| | Potassium Sorbate | 0.08 | 0.04 |
| | Xanthan | 0.30 | 0.14 |
| Liquid | Water | 40.24 | 19.20 |
| Ingredients | Glucose liquid | 9.36 | 4.46 |
| | Glycerine | 3.72 | 1.78 |
| | Polysorbate 60 | 1.11 | 0.53 |
| | Sorbitol | 0.40 | 0.19 |
| | Vanilla flavoring | 0.10 | 0.05 |
| Fatty | Rapeseed Oil | 4.02 | 1.92 |
| Phase | Lecithin | 0.40 | 0.19 |
| | Total | 100. | 47.72 |

Substrates made from this composition were frozen and then thawed to room temperature. It was observed that the freeze-thaw regiment did not result in any significant detrimental effects on the substrate. Samples of the substrate were also subjected to a high humidity environment. The samples remained stable.

Formulation 3

A composition having the following ingredients and amounts as provided below in Table 3 was prepared.

TABLE 3

| | | Wt. % |
|---|---|---|
| Dry | Gum Acacia | 8.81% |
| Ingredients | Microcrystalline Cellulose | 1.17% |
| | Xanthan | 0.59% |
| | Titanium Dioxide | 0.59% |
| | Modified Starch | 0.44% |
| | (Pre-gelatinised Waxy Maize | |
| | Starch) | |
| | Aspartame | 0.06% |
| | Potassium Sorbate | 0.09% |
| | Maize Starch | 8.37% |
| Liquid | Sorbitol | 8.81% |
| Ingredients | Glycerine | 5.87% |
| | Water | 64.62% |
| | Polysorbate 60 | 0.59% |
| | Total | 100% |

All the dry ingredients except titanium dioxide were dry blended in a mixer. All the liquid ingredients were blended in a separate mixture, to which titanium dioxide was then added and dispersed using a high shear mixer/homogenizer (mfr: Silverson Machines, Inc.; East Longmeadow, Mass.). Mixing was conducted for approximately 5 minutes. The liquid mixture was then added to the dry mixture and mixed until a well blended composition was achieved. The composition was then sieved through a fine mesh (size: 250 micrometers). The final composition was then made into substrates using either (1) an air operated spray gun (Ingersoll-Rand 672-067) or (2) a slot coater. Average thickness of each substrate varied from about 0.005 to about 0.025 inches.

The substrate sheets were oven dried in a series of heat treatments that averaged about 50° C. and totaled forty minutes of oven baking. The heat treatments were performed in an oven equipped with an Infrared heating element (IRT-Monocassette w/Control Unit from Solaronics IRT S.A.; Armentieres, France). The composition layer was considered to be substantially non-flowable after some oven heating, and considered fully cured prior to applying an image thereon. The samples were considered stable and capable of being handled in various climate conditions.

Formulation 4

A composition having the ingredients and amounts as provided below in Table 4 was prepared according to the procedure described in Example 3, except the citric acid was treated the same as titanium dioxide (i.e. added at a later stage).

TABLE 4

| | | % by wt. |
|---|---|---|
| Dry | Potassium Sorbate | 0.02% |
| Ingredients | Maize Starch | 13.93% |
| | Titanium Dioxide | 2.95% |
| | Modified Starch | 0.46% |
| | Icing Cane Sugar | 4.45% |
| | Dextrose Monohydrate | 3.72% |
| | Microcrystalline Cellulose | 5.65% |
| | Gum Acacia | 5.65% |
| Liquid | Glucose syrup | 8.45% |
| Ingredients | Glycerine | 3.32% |
| | Water | 49.83% |
| | Polysorbate 60 | 0.92% |
| | Sorbitol | 0.37% |
| | Citric Acid | 0.23% |
| | Vanilla Flavoring | 0.05% |
| | Total | 100% |

Substrate sheets were made from the composition using a slot coater, and heat treated according to the procedure described in Example 3. Samples were found to be stable and capable of being handled in various climate conditions.

Formulation 5

A composition having the following ingredients and amounts as provided below in Table 5 was prepared according to the procedure described in Example 3.

TABLE 5

| | | % by wt. |
|---|---|---|
| Dry | Maize Starch | 10.10 |
| Ingredients | Gum Acacia | 10.10 |
| | Xanthan | 1.37 |
| | Titanium Dioxide | 0.13 |
| | Potassium Sorbate | 0.10 |
| | Sweeteners | 0.06 |
| Liquid | Water | 60.63 |
| Ingredients | Polysorbate 60 | 0.67 |
| | Sorbitol | 16.84 |
| | Total | 100 |

Substrate sheets were made from the composition according to the procedure described in Example 3. Samples were found to be stable and capable of being handled in various climate conditions.

A number of embodiments of the invention have been described. Nevertheless, it will be understood that various modifications may be made without departing from the spirit and scope of the invention. For example, the steps of the methods disclosed herein can be performed in a different order and still achieve desirable results. Accordingly, other embodiments are within the scope of the following claims.

1. A method of making an edible substrate, the method comprising:
slot coating an edible material onto a backing material to form a layer of the edible material having a thickness of about 750 micrometers or less, the edible material having a viscosity in the range of approximately 1000-9000 centipoise; and
drying the layer of edible material to form an edible substrate that is adapted to receive an edible ink composition and be manually peeled away from the backing material.

2. The method of claim 1, further comprising printing an image onto the edible substrate with an edible ink composition.

3. The method of claim 2, wherein printing an image comprises applying an ink by lithographic or gravure printing.

4. The method of claim 1, further comprising:
removing the edible substrate from the backing material and applying the edible substrate to a baked good.

5. The method of claim 1, wherein the slot coating step comprises forming a layer of the edible material approximately 50 to about 750 micrometers thick.

6. The method of claim 1, wherein the edible material is substantially stable in low relative humidity environments.

7. The method of claim 1, wherein the backing material comprises a paper coated with one or more of the following: corona, wax, plastic, cellulose, polyethylene or polypropylene.

8. The method of claim 1, wherein the backing material comprises a polymeric film.

9. The method of claim 1, wherein the edible material is substantially stable when exposed to a temperature above about 90° C.

10. The method of claim 1, wherein the drying step comprises drying the edible material until the weight of the edible material is reduced by approximately 30 to 50%.

11. The method of claim 1, wherein the edible material includes water and wherein the drying step comprises removing more than about 90% of the water from the edible material.

12. The method of claim 1, further comprising:
selectively interrupting the slot coating to form a plurality of separate substantially contiguous layers of the edible material.

13. The method of claim 1, further comprising:
cutting the backing material with the edible material applied thereto into a plurality of discrete segments.

14. The method of claim 1, wherein the edible material is prepared by:
blending a dry mixture comprising about 5 wt % to about 28 wt % starch, up to about 16 wt % stabilizer and about 1 wt % to about 20 wt % texturizer;
blending a liquid mixture comprising about 25wt% to about 70 wt % water, about 5 wt % to about 35 wt % humectant, up to about 10 wt % emulsifier, and up to about 10 wt % plasticizer; and
combining the dry mixture and the liquid mixture to provide a flowable mixture.

15. The method of claim 1, further comprising:
spraying the edible material onto the backing material in combination with the slot-coating to form the substantially contiguous layer the edible material.

16. The method of claim 1, wherein the edible material comprises:
an emulsifier;
a plasticizer;
a stabilizer;
a humectant;
a texturizer;
starch; and
water.

17. The method of claim 16, wherein the edible material, when formed into a substantially non-flowable substrate, is stable in an environment having a temperature about −35° C. to about 275° C., and a humidity level greater than about 5%.

18. The method of claim 16, wherein the emulsifier is present at up to about 10 wt % of the total edible material.

19. The method of claim 16, wherein the plasticizer is present at up to about 10 wt % of the total edible material.

20. The method of claim 16, wherein the stabilizer is present at up to about 16 wt % of the total edible material.

21. The method of claim 16, wherein the humectant is present at about 5 wt % to about 35 wt % of the total edible material.

22. The method of claim 16, wherein the texturizer is present at about 1 wt % to about 20 wt % of the total edible material.

23. The method of claim 16, wherein the starch is present at about 5 wt % to about 28 wt % of the total edible material.

24. The method of claim 16, wherein the water is present at about 25 wt % to about 70 wt % of the total edible material.

25. The method of claim 16, wherein the edible material further comprises a disintegrant.

26. The method of claim 16, wherein the edible material comprises:
up to about 10 wt % emulsifier;
up to about 10 wt % plasticizer;
up to about 16 wt % stabilizer;
about 5 wt % to about 35 wt % humectant;
about 1 wt % to about 20 wt % texturizer;
starch; and
water.

27. A system for making an edible substrate, comprising:
a reservoir to contain an edible material;
a slot-coater to receive the edible material from the reservoir and to slot-coat the edible material onto a backing material to form a layer of the edible material having a thickness of about 750 micrometers or less;
a transport mechanism to transport a backing material past the slot coater;
a controller to regulate slot-coating of the edible material from the slot-coater onto the backing material; and
a drying system comprising a heating mechanism to dry the layer of edible material and thereby form an edible substrate adapted to receive an edible ink composition and be manually peeled away from the backing material.

28. The system of claim 27, wherein the controller is adapted to interrupt slot-coating to form a plurality of separate layers of the edible material, the separate layers separated by a gap.

29. The system of claim 27, wherein the drying system is configured to dry the layer of edible material so that moisture is removed to reduce a weight of the edible material by approximately 30 to 50%.

30. The system of claim 29, wherein the drying system is further configured to remove at least about 90% of water included in the edible material.

31. The system of claim 28, further comprising:
a cutting system configured to cut the backing material into a plurality of discrete segments at the gap separating the plurality of layers of the edible material.

32. The system of claim 31, further comprising:
a rack system including a plurality of arms, where each arm is configured to receive a discrete segment of the backing material and a layer of edible material supported thereon.

33. The system of claim 32, wherein the rack system further includes one or more drying units configured to expose a layer of the edible material to heated air.

34. The system of claim 33, wherein drying units of the rack system are configured to remove at least about 90% of water included in the edible material.

35. The system of claim 27, further comprising:
a printing device configured to apply an image to an edible substrate using an edible ink composition.

36. The system of claim 35, wherein the printing device is configured to apply an image by lithographic blanket transfer printing, flexographic printing, or gravure printing.

37. The system of claim 27, wherein the edible substrate is approximately 50 to 750 micrometers in thickness.

38. The system of claim 27, wherein the edible material has a viscosity in the range of approximately 1000-9000 centipoise.

39. The system of claim 27, wherein the edible material is substantially stable in low relative humidity environments.

40. The system of claim 27, wherein the edible material comprises:
up to about 10 wt % emulsifier;
up to about 10 wt % plasticizer;
up to about 16 wt % stabilizer;
about 5 wt % to about 35 wt % humectant;
about 1 wt % to about 20 wt % texturizer;
starch; and
water.

41. The system of claim 27, wherein the backing material comprises a paper coated with one or more of the following: corona, wax, plastic, cellulose, polyethylene or polypropylene.

42. The system of claim 27, wherein the edible material is substantially stable when exposed to a temperature above about 90° C.

43. A method of making an edible substrate, the method comprising:
spraying an edible material onto a backing material to form a layer of the edible material having a thickness of about 750 micrometers or less, the edible material having a viscosity in the range of approximately 1000-9000 centipoise; and
drying the layer of edible material to form an edible substrate that is adapted to receive an edible ink composition and be manually peeled away from the backing material.
